(19) United States
(12) Patent Application Publication
(10) Pub. No.: US 2024/0412099 A1
(43) Pub. Date: Dec. 12, 2024

(54) MACHINE LEARNING FOR SEMI-SUPERVISED WORKLOAD CLASSIFICATION

(71) Applicant: INTERNATIONAL BUSINESS MACHINES CORPORATION, Armonk, NY (US)

(72) Inventors: Xi YANG, Apex, NC (US); Rohan R. ARORA, Champaign, IL (US); Yu DENG, Yorktown Heights, NY (US); Daby Mousse SOW, Croton on Hudson, NY (US)

(21) Appl. No.: 18/331,400

(22) Filed: Jun. 8, 2023

(51) Int. Cl. G06N 20/00

(52) U.S. Cl. CPC G06N 20/00

(57) ABSTRACT

Computer implemented methods, systems, and computer program products include program code executing on a processor(s) that obtain temporal input from computing resources. The processor(s) extracts patterns from the temporal input, determine if relevant domain knowledge is available. If relevant data is available, the processor(s) utilizes it to identify patterns indicating anomalous workloads, label data in the patterns, and generate anomaly scores. If relevant data is not available, the processor(s) applies unsupervised anomaly detection algorithm(s) to identify patterns as indicative of anomalous workloads and label these data. The processor(s) generates anomaly scores for the labeled data and unlabeled data. The processor(s) determine which patterns indicates anomalous data or normal data by comparing relevant anomaly scores to a pre-defined threshold.

### BACKGROUND

The present invention relates generally to the field of distributed computing management and more particularly to workload classification for optimization of computing resources including managing data center energy consumption.

Workload management in computing systems can provide various benefits for resource consumers, including but not limited to, reducing the data center energy consumption, decreasing the carbon footprint, and increasing the revenue for these consumers. Classification of workloads, including identifying workloads as non-productive workloads and hotspots (e.g., hotspots are characterized by high CPU/memory utilization for a short duration), as part of this management effort.

### SUMMARY

Shortcomings of the prior art are overcome, and additional advantages are provided through the provision of a computer-implemented method for classifying and resolving anomalous workloads in a computing environment. The computer-implemented method can include: obtaining, by one or more processors, temporal input from resources comprising a computing system; extracting, by the one or more processors, patterns from the temporal input; determining, by the one or more processors, if domain knowledge is available to assist in identifying anomalous workloads in the extracted patterns based on the temporal input; based on determining that domain knowledge is available to assist in the identifying, utilizing the domain knowledge to perform a workload pattern analysis to identify a portion of the patterns as indicative of anomalous workloads, labeling data comprising the portion of the patterns, and generating a first set of anomaly scores for the labelled data comprising the portion of the patterns; based on determining that domain knowledge is not available to assist in the identifying, applying one or more unsupervised anomaly detection algorithms to identify an additional portion of the patterns as indicative of the anomalous workloads and labeling data comprising the additional portion of the patterns; generating, by the one or more processors, a second set of anomaly scores for the labeled data comprising the portion of the patterns and the additional portion of the pattern and unlabeled data comprising the extracted patterns; for each pattern of the patterns, calculating, by the one or more processors, a weighted sum comprising a combined anomaly score for the pattern based on combining one or more anomaly scores for the pattern selected one or more of the first set of anomaly scores and the second set of anomaly scores; and determining, by the one or more processors, for each pattern of the patterns, whether the pattern indicates anomalous data or normal data based on utilizing an inference component to compare the combined anomaly score for each pattern to a pre-defined threshold.

Shortcomings of the prior art are overcome, and additional advantages are provided through the provision of a computer program product for classifying and resolving anomalous workloads in a computing environment. The computer program product comprises a storage medium readable by a one or more processors and storing instructions for execution by the one or more processors for performing a method. The method includes, for instance: obtaining, by the one or more processors, temporal input from resources comprising a computing system; extracting, by the one or more processors, patterns from the temporal input; determining, by the one or more processors, if domain knowledge is available to assist in identifying anomalous workloads in the extracted patterns based on the temporal input; based on determining that domain knowledge is available to assist in the identifying, utilizing the domain knowledge to perform a workload pattern analysis to identify a portion of the patterns as indicative of anomalous workloads, labeling data comprising the portion of the patterns, and generating a first set of anomaly scores for the labelled data comprising the portion of the patterns; based on determining that domain knowledge is not available to assist in the identifying, applying one or more unsupervised anomaly detection algorithms to identify an additional portion of the patterns as indicative of the anomalous workloads and labeling data comprising the additional portion of the patterns; generating, by the one or more processors, a second set of anomaly scores for the labeled data comprising the portion of the patterns and the additional portion of the pattern and unlabeled data comprising the extracted patterns; for each pattern of the patterns, calculating, by the one or more processors, a weighted sum comprising a combined anomaly score for the pattern based on combining one or more anomaly scores for the pattern selected one or more of the first set of anomaly scores and the second set of anomaly scores; and determining, by the one or more processors, for each pattern of the patterns, whether the pattern indicates anomalous data or normal data based on utilizing an inference component to compare the combined anomaly score for each pattern to a pre-defined threshold.

Shortcomings of the prior art are overcome, and additional advantages are provided through the provision of a system for classifying and resolving anomalous workloads in a computing environment. The system includes: a memory, one or more processors in communication with the memory, and program instructions executable by the one or more processors via the memory to perform a method. The method includes, for instance: obtaining, by the one or more processors, temporal input from resources comprising a computing system; extracting, by the one or more processors, patterns from the temporal input; determining, by the one or more processors, if domain knowledge is available to assist in identifying anomalous workloads in the extracted patterns based on the temporal input; based on determining that domain knowledge is available to assist in the identifying, utilizing the domain knowledge to perform a workload pattern analysis to identify a portion of the patterns as indicative of anomalous workloads, labeling data comprising the portion of the patterns, and generating a first set of anomaly scores for the labelled data comprising the portion of the patterns; based on determining that domain knowledge is not available to assist in the identifying, applying one or more unsupervised anomaly detection algorithms to identify an additional portion of the patterns as indicative of the anomalous workloads and labeling data comprising the additional portion of the patterns; generating, by the one or more processors, a second set of anomaly scores for the labeled data comprising the portion of the patterns and the additional portion of the pattern and unlabeled data comprising the extracted patterns; for each pattern of the patterns, calculating, by the one or more processors, a weighted sum comprising a combined anomaly score for the pattern based on combining one or more anomaly scores for the pattern selected one or more of the first set of anomaly scores and the second set of anomaly scores; and determining, by the one or more processors, for each pattern of the patterns, whether the pattern indicates anomalous data or normal data based on utilizing an inference component to compare the combined anomaly score for each pattern to a pre-defined threshold.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects. For example, in some embodiments, program code executing on one or more processors provides explainability, for subsequent execution of the method, by updating a semi-supervised anomaly detection algorithm by utilizing patterns of the patterns determined to be anomalous data as training data, and updating the domain knowledge with patterns of the patterns determined to be the normal and abnormal data.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present invention;

FIG. 2 is a workflow that provides an overview of various aspects performed by the program code (executing on one or more processors) in some embodiments of the present invention;

FIG. 3 is a combined workflow and technical architecture illustration that illustrates various components of some embodiments of the present invention; and

FIG. 4 illustrates aspects of calculating an anomaly score in some embodiments of the present invention.

### DETAILED DESCRIPTION

Classification of workloads, including identifying workloads as non-productive workloads and hotspots, provides various benefits for resource consumers and for the technical infrastructure itself, including but not limited to, reducing the data center energy consumption, decreasing the carbon footprint, and increasing the revenue for these consumers. The examples herein include computer-implemented methods, computer program products, and computer systems that detect detecting anomalous workloads in a semi-supervised manner by using temporal multi-channel metrics data as input.

As explained herein, embodiments of the present invention advantageously combine at least three types of techniques in a novel manner to generate a model that comprises program code to identify anomalous data from different channels and to consistently improve the accuracy of the model through subsequent utilization. Embodiments of the present invention incorporate workload pattern analysis, an inference component, and explainability and utilize the advantages of these components, together, to identify anomalies. Through workload pattern analysis, the program code comprehensively incorporates prior knowledge to characterize various workload patterns. The program code utilizes the prior knowledge to determine some labeled data and can bootstrap the described semi-supervised machine learning techniques disclosed herein to this workload analysis to explore novel workload patterns further. The inference component of the program code balance classification results from this prior knowledge-based workload pattern analysis and data-driven machine learning techniques to label additional data. The program code can provide explainability for the classification results and iteratively enrich both the prior knowledge of the workload analysis and improve the classification performance of the inference component.

Embodiments of the present invention are inextricably tied to computing and are directed to a practical application. The examples described herein are inextricably linked to computing as the examples herein provide systems, methods, and computer program products that, for example, optimize resource usage in a computing environment, based on providing insight into both workloads and utilizing this workload data to make and implement technical infrastructure decisions. For example, in some embodiments, program code executed by one or more processors discovers resource conservation opportunities in large data centers and computing environments by identifying inactive resources. In some embodiments of the present invention, the program code can automatically decommission these inactive resources. By recognizing these resources, the program code can reduce data center energy consumption, decrease the carbon footprint of the data center, and increase the revenue of the data center users.

To realize a practical application to which the embodiments described herein are directed, the program code identifies inactive resources by classifying workloads as anomalous. These workloads can include workloads handled by one or more of virtual machines (VMs), cloud native resources (e.g., containers, server-less). Anomalous workloads can include both non-productive workloads (e.g., workloads not actively producing any useful work) and hotspots (e.g., workloads leading to overloaded resources). In the case of non-productive workloads, the program code can identify these workloads and, in some cases, automatically shut down the resources that handle these workloads. In the case of hotspots, in some examples, the program code can migrate these workloads and/or portions of these workloads to more efficient hardware and/or software resources in the technical environment (e.g., data center). The program code in embodiments of the present invention detects anomalous workloads based on assuming that anomalous workloads are divergent from general or normal patterns. The program code generates and continually tunes and updates a model to perform detection based on semi-supervised anomaly detection. The program code (and the model) utilize: 1) prior domain knowledge; and 2) machine-learning techniques. Existing approaches for classifying workloads, which include detecting non-productive workloads, have various shortcomings that are overcome by aspects of the examples herein. Existing approaches to classifying workloads generally fall into two categories: 1) resource analysis; and 2) data-driven models. As will be discussed herein, the examples herein leverage the advantages of both approaches while utilizing this combined approach to benefit from the advantages of each type of approach. First, identifying workloads as non-productive can include detecting non-productive/idle servers. Some existing approaches identify these servers based on analyzing resource utilization and assume that the non-productive workloads have lower resource consumption than expected. But these approaches can produce unreliable results because resource idleness might not be necessary to indicate utilization idleness. To address the unreliable results, other existing approaches include supervised machine learning and require the manual creation of ground-truth labels for the workloads, which forms the foundation of these systems and without this foundation, the automated processes cannot execute accurately. Unfortunately, acquiring large amounts of labeled data is a pre-requisite to conduct these supervised approaches and acquiring these data is both time-consuming and labor-intensive. The second type of existing approaches, the machine-learning techniques, omit this labeling effort and focus on identifying overloaded and underloaded resource utilization by applying prior knowledge (e.g., thresholding-based methods), but prior knowledge is often incomplete and/or inaccurate and these shortcoming are reflected in the results. Limiting workload analysis to historical activities, whether based on analyzing the physical machines, based on either of machine utilization or workload data analysis, in the existing approaches, does not provide a comprehensive understanding of workloads processed in a computing environment. As discussed herein, embodiments of the present invention represent a significant improvement to these existing approaches at least because they leverage the advantages of prior knowledge (e.g., workload pattern analytics) as well as data-based machine learning analytics.

In the examples herein, program code executing on one or more processors can assess workloads by capturing complementary information across multi-channel metrics and filter out the redundant information; various examples herein combine unsupervised anomaly detection with domain knowledge. One advantage of the examples herein over existing approaches in that the examples herein include semi-supervised approaches which reduce the need for labeled data (which is required by supervised machine learning algorithms in existing approaches) extensively. Additionally, the examples herein combine various supervised and unsupervised techniques and direct this combination to a specific practical application, computing anomaly scores which the program code can utilize for workload classification with explainability. As discussed above acquiring large amounts of labeled data is both time-consuming and labor-intensive in existing approaches and the examples herein alleviate this issues by including program code that characterizes various workload patterns based on metrics data and prior domain knowledge to reduce the amount of labeled data, which improves performance and explainability. The workload patterns that the program code utilizes can include both explicit known workload patterns conveyed by prior knowledge and implicit novel patterns conveyed by data. As such, the examples herein utilize semi-supervised learning and an inference component. In the examples, herein, after the program code has detected anomalous workloads, the examples herein gain explainability for better characterizing the workload patterns moving forward. The on-going tuning and improvement of various aspects of the present invention are discussed herein and form what can be understood as an explainability component; the program code can utilize identified anomalies to tune machine learning algorithms used to identify anomalies and the program code can utilize data not found to be anomalous to update prior knowledge used by the program code to characterize workloads. Semi-supervised learning, when compared to supervised learning, provides an advantage because semi-supervised systems require fewer labels. Embodiments of the present invention can consider inactive workloads and/or hotspots as anomalies and classify them using the described a semi-supervised anomaly detector, which utilizes only a small set of labeled data when compared to what is utilized in supervised learning system.

The examples herein provide significant advantages over existing workload assessment and management tools. An advantage provided by the examples herein includes but is not limited to embedding temporal multi-channel input. Embedding temporal multi-channel input includes program code executing on one or more processors incorporating both temporal patterns as well as structural patterns across different timestamps and metrics, so that the patterns for the workloads can be better characterized in a data-driven manner. Thus, in embodiments of the present invention, the program code can capture the complementary information across multi-channel metrics and meanwhile filter out the redundant information, while the existing approaches either focus on workload pattern analysis based on prior knowledge over resource utilization or are machine-learning-based methods that are mainly data-driven.

Various aspects of the embodiments herein distinguish approaches herein from existing approaches to optimizing resource usage in computing environments such as large data centers. The aspects described herein are not exhaustive and provided by way of example. As noted above, in embodiments of the present invention, the program code embeds temporal multi-channel data thus incorporating both temporal patterns as well as structural patterns with complementary information across different metrics. The program code also performs a semi-supervised workload classification (e.g., utilizing few-shot labeled data). Given a small set of labeled data (learned by workload pattern analysis or unsupervised anomaly detection), the program code can utilize a semi-supervised anomaly detection to capture anomalous patterns covered in the labeled data and to discover novel anomalous patterns in unlabeled data. The program code also performs a workload pattern analysis which includes characterizing patterns for various types of workloads based on prior knowledge over temporal multi-channel metrics. The program code also employs an inference component. The program code utilizes the inference component. The program code combines the anomalous scores learned by the workload pattern analysis and the semi-supervised anomaly detection results into an inference component (to take the respective powers of the scored learned by the workload pattern analysis and of the semi-supervised anomaly detection results). The results provided by the program code provide explainability meaning that based on the detection results, the program code can explore further explainability to characterize the anomalous workloads and to continually enrich the domain knowledge. Explainability (also referred to as “interpretability”) is the concept that a machine learning model and its output can be explained in a way that “makes sense” to a human being at an acceptable level.

In some embodiments of the present invention, the program code generates and continually refines a model which detects anomalous data and hence, enables the program code to classify workloads, including identifying detecting non-productive workloads. The model comprises domain knowledge and a few-shot anomaly detection algorithm (also referred to as a few-shot anomaly detection model), which are both continually refined by the program code. In some embodiments of the present invention, program code executed by one or more processor extracts both temporal and structural patterns from resources in a computing system, including from temporal multi-channel metric inputs. The program code can apply domain knowledge (e.g., pre-defined criteria) to characterize the anomalous workloads. By characterizing these anomalous workloads, the program code generates a set of labels for the data. If there is no domain knowledge the program code can utilize an unsupervised machine learning approach to identify a set of anomalous data with high confidence. Thus, whether utilizing domain knowledge or unsupervised learning, the program code can identify some anomalous data and thus generate a set of labeled data. The program code obtains the set of labeled data unlabeled data as inputs (the amount of labeled data is generally small when compared to the amount of unlabeled data) and applies a few-shot anomaly detection algorithm to analyze the inputs. A few-shot anomaly detection algorithm is a class of anomaly detection algorithm that is trained on a few examples of a normal class and is not trained on any examples of an anomalous class. The program code can utilize the few-shot anomaly detection algorithm to exploit the patterns contained in the set of labeled data and explore unknown novel anomalous patterns from the unlabeled data. The program code outputs the results of the workload pattern analysis and applying the few-shot anomaly detection algorithm, and based on these outputs, the program code performs an inference, achieving more reliable detection results.

One or more aspects of the present invention are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing a process (or multiple processes) that, e.g., facilitates granular real-time data attainment and delivery including as relevant to soliciting, generating, and timely transmitting, granular product review to consumers. Aspects of the present invention are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

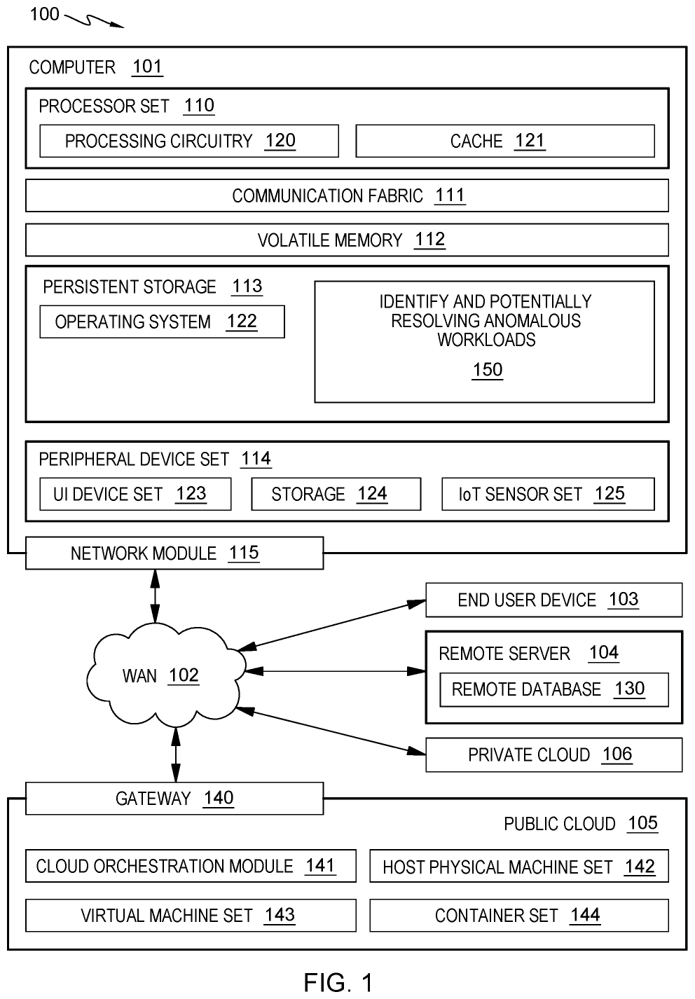

One example of a computing environment to perform, incorporate and/or use one or more aspects of the present invention is described with reference to FIG. 1. In one example, a computing environment 100 contains an example of an environment for the execution of at least some of the computer code involved in performing the inventive methods, such as a code block for identifying and potentially resolving anomalous workloads 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

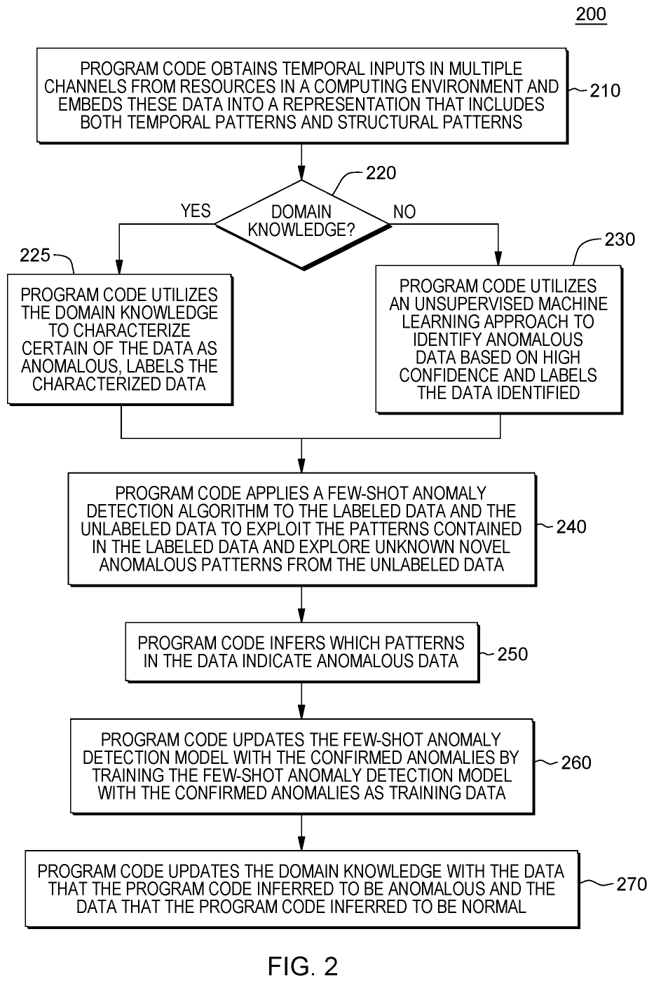

FIG. 2 is a general workflow 200 that illustrates various aspects of some embodiments of the present invention. The program code in embodiments of the present invention utilizes both prior domain knowledge and machine learning-based techniques (e.g., a few-shot anomaly detection algorithm and/or supervised learning) to identify anomalous workloads. Identifying these anomalous workloads is an iterative process and the program code continually updates both the domain knowledge and the algorithm(s) applied by the machine learning-based techniques to increase accuracy with each iteration. The combination of the domain knowledge and the algorithm(s) can be understood as a model that the program code generates, updates, and applies. The program code obtains temporal inputs in multiple channels from resources in a computing environment and embeds these data into a representation which includes both temporal patterns and structural patterns (210). The program code determines if there is prior domain knowledge (220). The program code labels a portion of the data if there is domain knowledge by utilizing the domain knowledge to characterize certain of the data as anomalous, labeling the characterized data (225). This type of data labeling based on prior knowledge can be understood as workload pattern analysis. The program code performs the workload pattern analysis on the (original) temporal input. The program code labels a portion of the data if there is no domain knowledge by utilizing an unsupervised machine learning approach (e.g., dimension reduction, clustering, etc.) to identify a set of anomalous data with high confidence and labeling the data identified with the unsupervised machine learning approach (230). The program code applies a few-shot anomaly detection algorithm to the labeled data and the unlabeled data to exploit the patterns contained in the labeled data and explore unknown novel anomalous patterns from the unlabeled data (240). The program code infers (e.g., applying an inference component) which patterns in the data indicate anomalous data based on the results from the domain knowledge or unsupervised machine learning approach and the few-shot anomaly detection algorithm (250). In some examples, this detection can be performed by program code comprising an inference component; the inference component performs a binary detection of anomalies in the labeled and unlabeled data based on the workload pattern analysis (using the prior domain knowledge) and the few-shot anomaly detection. The program code updates the few-shot anomaly detection model with the confirmed anomalies by training the few-shot anomaly detection model with the confirmed anomalies as training data (260). The program code updates the prior domain knowledge (e.g., used by the program code to perform a workload pattern analysis) with the data that the program code inferred to be inferred to be normal and data that the program code inferred to be anomalous (270). In some examples, the inference is binary and thus, the program code classifies the patterns as either anomalous or normal. Thus, the program code provides the normal data as prior knowledge, to be used in future workload pattern analyses.

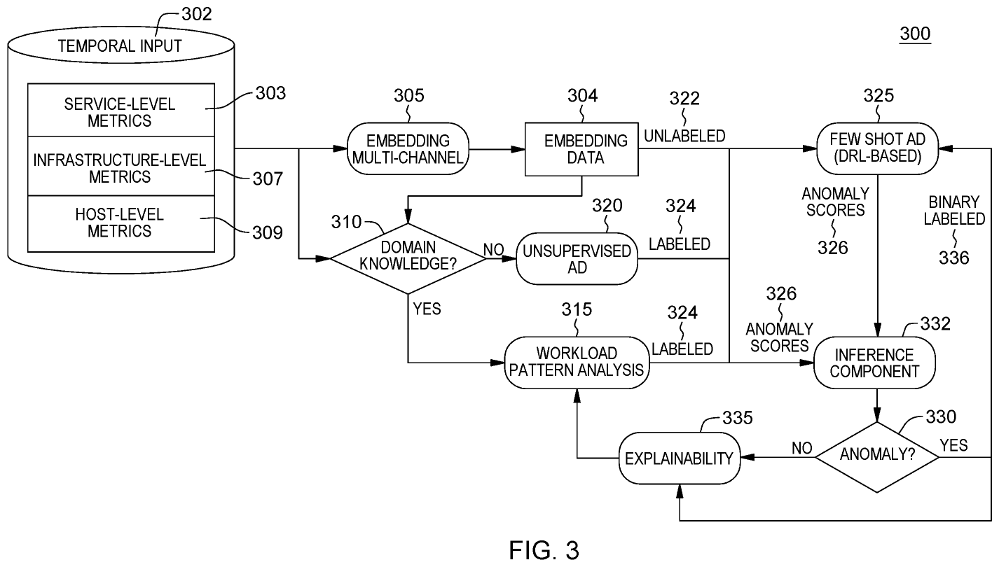

FIG. 3 depicts both various aspects of a technical architecture that performs a workflow also depicted in FIG. 3. Thus, FIG. 3 is a combination workflow and architecture 300 illustration. FIG. 3 illustrates the temporal input 302 which the program code obtains, extracts structural patterns and temporal patterns from the temporal input 302, and embeds the patterns to generate embedded data 304 (305). The temporal input 302 from resources in a computing system include, but are not limited to, service level metrics 303 (e.g., number of calls, number of erroneous calls, number of connections, number of 2xx, 4xx, and 5xx requests), infrastructure level metrics 307 (e.g., CPU (central processing unit) usage, memory usage, memory total cache, block IO (input/output) write), and host-level metrics 309 (e.g., CPU utilization of each node, memory utilization of each node). The temporal input 302 can be understood as a sliding window with multi-channel metrics. The sliding window is a period around a given timestamp (i.e., the temporal parameter of the input). The multi-channel metrics (e.g., service level metrics 303, infrastructure level metrics 307, and host-level metrics 309) provide various structural data. These different channels convey complementary information, the metrics are of different importance, and, thus, the program code can mutually correlate the metrics in the same and in different channels with each other. By embedding the multi-channel (e.g., the extracted patterns from the input) or practicing attention-based bidirectional embedding (305), the program code captures temporally dependent patterns and filters out noisy and redundant information across the different metrics (e.g., service level metrics 303, infrastructure level metrics 307, and host-level metrics 309). The program code extracts patterns that are both structural and temporal from the temporal input 302.

The program code performs a deep reinforcement learning-based anomaly detection on the embedded data. This process includes few shot anomaly detection, which is a data-driven machine learning process. To that end, after embedding the data, the program code, in the illustrated example, generates a set of labeled data representing anomalous workloads from the embedded data. The program code can label the data both by utilizing domain knowledge and/or by applying an unsupervised anomaly detection algorithm (320). However, the program code performs the workload pattern analysis on the temporal input (the original data) rather than on the embedded data. The inputs to this algorithm are labeled data 322 and unlabeled data 324 and the output is anomaly scores 326. To generate these inputs from the embedded data 304 or the temporal input 302, in the illustrated example, the program code determines if there is any domain knowledge (310). The program code also obtains anomalies (i.e., a set of labeled anomalous workloads 324) and provides these anomalies to a deep learning reinforcement learning-based few-shot anomaly detection algorithm. If domain knowledge is available, the program code utilizes the domain knowledge to perform a workload pattern analysis (315). The program code utilizes the domain knowledge to assist in identifying anomalous workloads in the extracted patterns based on the temporal input. If there is no domain knowledge available, the program code performs an unsupervised anomaly detection (e.g., applying a machine learning algorithm) (320). Based on utilizing the domain knowledge or applying unsupervised anomaly detection, the program code generates labeled data 324 which comprises a set of labeled anomalous workloads.

A non-limiting type of unsupervised anomaly detection (320) that can be utilized in some examples herein to generate labeled data 324 (e.g., a set of labeled anomalous workloads) is ensemble anomaly detection. Ensemble learning (or ensemble anomaly detection) includes utilizing density and rank based algorithms (e.g., LOF, COF, and INFLO). By applying these algorithms, the program code can assign an anomaly score is assigned to an object (e.g., a pattern in the data) based on density comparison of the object with its k nearest neighbors. In this example, an object is considered an anomaly if its anomaly score is greater than a pre-defined threshold. These ensemble learning algorithms can be based on the notion of rank and use the concept that if k nearest neighbors of an object consider the object as one of their close neighbors, then it is less likely to be an anomaly. Ensemble methods of anomaly detection combine various approaches/algorithms to limit bias-variance. A particular algorithm may be well-suited to the properties of one data set and be successful in detecting anomalous observations of a particular application domain but may fail to work with other datasets whose characteristics do not agree with the first dataset. An ensemble method alleviates the mismatch between an algorithm and an application because in an ensemble method, multiple algorithms are pooled before a final decision is made.

To obtain anomaly scores 326 (a desired output), the program code applies a few-shot anomaly detection algorithm (325). Applying the few-shot anomaly detection algorithm exploits the anomalous patterns in the labeled data 324 and enables the program code to explore unknown novel anomalous patterns in the unlabeled data 322.

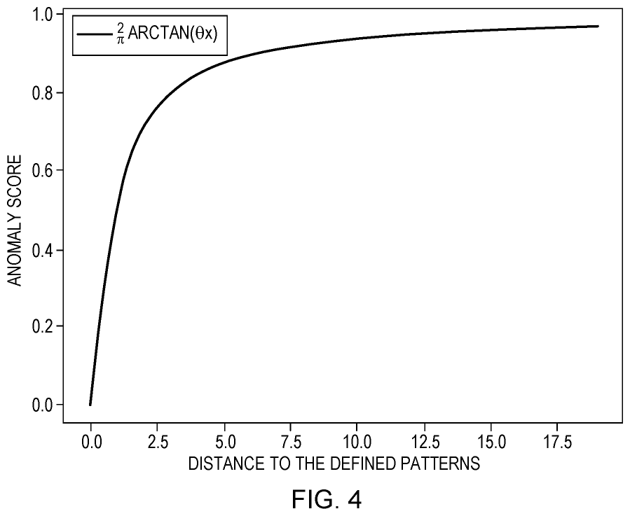

As aforementioned, the program code determines if there is domain knowledge that the program code can utilize the classify the workload data (310). If the program code determines that there is domain knowledge, the program code can analyze workload patterns in the original data (temporal input 302) utilizing the domain knowledge (315). Based on this analysis, the program code can also assign anomaly scores 326 to the labeled data 324 that was labeled based on the domain knowledge. The inputs to this process are the original temporal metrics (e.g., the temporal input 302) and the domain knowledge. In performing the workload pattern analysis (315), the program code can map data in the temporal input 302 to buckets comprising components in the computer system, including but not limited databases and application servers. The program code can identify patterns across the lifecycles of the components of the computer system. To determine an anomaly score, the program code can calculate a distance that represents a divergence between the domain knowledge and incoming patterns (in the temporal input 302) against representative patterns for the domain including but not limited to, resource utilization, network traffic, and I/O. FIG. 4 illustrates that the larger a distance (determined by the program code in this analysis), the larger the anomaly score. In FIG. 4, the x-axis represents a distance to the defined patterns and the y-axis represents the anomaly scores.

As illustrated in FIG. 3, the program code can generate anomaly scores 326 for data patterns in the temporal input 302 both by utilizing machine learning, including, specifically, applying a few-shot anomaly detection algorithm (325), and/or by performing a workload pattern analysis utilizing domain knowledge (315). The program code provides the anomaly scores 326 to an inference component 332. The inference component 332 is illustrated as a separate element of the program code for illustrative purposes only just as other elements of the program code are illustrated separately for illustrative purposes and not to limit the technical architecture of the program code. For ease of understanding, anomaly score s₁ can be used to refer to anomaly scores 326 returned based on the program code applying a data-driving deep reinforcement learning-based few-shot anomaly detection algorithm. Meanwhile, anomaly score s₂ represents anomaly scores 326 generated by the program code based on the program code applying domain knowledge (e.g., prior knowledge) and performing a workload pattern analysis utilizing this domain knowledge. Meanwhile, a represents a weight. The inference component 332 of the program code determines whether each pattern represents an anomaly or not, providing data with binary labels 336 (e.g., normal or anomaly) as outputs (330). The program code can detect the anomalies utilizing the logic provided below.

If αs₁+(1−α)s₂>threshold→anomaly workloads, where threshold is pre-defined, else→normal.

Thus, the program code leverages both types of anomaly scores 326, s₁ and s₂, comparing the combination to a pre-defined threshold to determine whether to detect an anomaly (330). The program code determines whether a resultant weighted sum represents an anomaly or normal data. The program code classifies data patterns in the temporal input 302 as normal or an anomaly, generating binary labeled data 336. As discussed above, the results provided by the program code provide explainability meaning that based on the detection results, the program code can explore further explainability to characterize the anomalous workloads and to continually enrich the domain knowledge. This, in the examples herein, the program code evaluates a final anomaly score for each pattern that is calculated as a weighted sum of the two sets.

Once the program code has generated the binary labeled data 336, the program code interprets these data to provide explainability (335), including but not limited to most outlying metrics, groups of anomalies with similar patterns, etc. To provide explainability (335), the program code can select or weigh features for imbalanced binary classification. In this manner, the program code can expose the classification accuracy of the program code, including of outliers and show the degree of the outliers. The program code can also perform attention-guided feature weighting. The program code can perform a score-and-search approach to find a feature subspace (e.g., perform a greedy search detect the subspace with the largest outlierness degree). The program code can also re-map the binary labeled data to infrastructure metrics, including but not limited to resource utilization, network traffic, and/or I/O. The program code can also provide the results (e.g., binary labeled data) to the domain knowledge (e.g., the anomaly patterns identified by the program code) and to the few-shot algorithm (e.g., the identified normal patterns) to tune these aspects for accuracy in future iterations of the identification process.

In some embodiments of the present invention, the program code identifies the anomaly patterns as indicating non-productive workloads or hotspots. Based on identifying a non-productive workload, the program code can utilize the re-mapping to automatically shut down one or more of the resources that handle this workload. Based on identifying a hotspots, the program code can utilize the re-mapping to migrate this workload and/or portions of this workload to more efficient hardware and/or software resource(s) in the technical environment.

Embodiments of the present invention include computer-implemented method, computer programs products, and computer systems for classifying and resolving anomalous workloads. In some examples, program code executing on one or more processors obtains temporal input from resources comprising a computing system. The program code extracts patterns from the temporal input. The program code determines if domain knowledge is available to assist in identifying anomalous workloads in the temporal input based on the extracted patterns. Based on determining that domain knowledge is available to assist in the identifying, the program code utilizes the domain knowledge to perform a workload pattern analysis to identify a portion of the patterns as indicative of anomalous workloads, labels data comprising the portion of the patterns, and generates a first set of anomaly scores for the labeled data comprising the portion of the patterns. Based on determining that domain knowledge is not available to assist in the identifying, the program code applies one or more unsupervised anomaly detection algorithm to identify an additional portion of the patterns as indicative of the anomalous workloads and labels data comprising the additional portion of the patterns. The program code generates a second set of anomaly scores for the labeled data comprising the portion of the patterns and the additional portion of the pattern and unlabeled data comprising the extracted patterns. The program code determines, for each pattern of the patterns, whether the pattern indicates anomalous data or normal data based on utilizing an inference component to compare one or more anomaly scores for each pattern to a pre-defined threshold. The one or more anomaly scores for each pattern are selected from one or more of the first set of anomaly scores or the second set of anomaly scores.

In some examples, the program code updates the unsupervised anomaly detection algorithm by utilizing patterns of the patterns determined to be anomalous data as training data. The program code can also update the domain knowledge with patterns of the patterns determined to be the normal data.

In some examples, the program code generating the second set of anomaly scores for the labeled data comprises the program code applying a few-shot anomaly detection model.

In some examples, the temporal input comprises service level metrics, infrastructure level metrics, and host-level metrics.

In some examples, the temporal input comprises a multi-channel comprised of system metrics from the resources comprising the computing system.

In some examples, the program code extracting patterns from the temporal input comprises: embedding a multi-channel with the patterns; and filtering out noisy and redundant information across different metrics comprising the temporal output.

In some examples, the patterns comprise temporal patterns and structural patterns in data comprising the temporal output.

In some examples, the one or more unsupervised anomaly detection algorithm comprise ensemble learning.

In some examples, the labeled data identified by applying the one or more unsupervised anomaly detection algorithm comprises data comprising patterns from the patterns classified as anomalous with high confidence by the one or more unsupervised anomaly detection algorithm.

In some examples, the program code trains the few-shot anomaly detection model with the training data.

In some examples, the program code enhances the patterns determined to indicate anomalous data to provide explainability, by doing one or more of the following: selecting or weighing features in the patterns determined to indicate anomalous data for imbalanced binary classification, performing attention-guided feature weighting, and/or re-mapping the patterns determined to indicate anomalous data to infrastructure metrics of the computing system.

In some examples, the program code updates the domain knowledge with the enhanced patterns.

In some examples, based on the determining concluding that a given pattern indicates anomalous data, the program code determines, for the given pattern whether the given pattern is comprised in a non-productive workload or in a hotspot.

In some examples, based on determining that the given pattern is comprised in a non-productive workload, the program code automatically shuts down at least one resource of the computing system that handles the non-productive workload.

In some examples, based on determining that the given pattern is comprised in a hotspot, the program code migrates at least a portion of the hotspot to a new resource in the computing system.

In some examples, generating the anomaly scores comprises: for a portion of the labeled data labeled based on the workload pattern analysis, calculating, a distance that represents a divergence between the extracted patterns against representative patterns for the domain comprising the domain knowledge, and correlating the distance with the anomaly scores; and for portions of the data not labeled based on the workload pattern analysis, applying a few-shot anomaly detection model to generate the anomaly scores.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
obtaining, by one or more processors, temporal input from resources comprising a computing system;
extracting, by the one or more processors, patterns from the temporal input;
determining, by the one or more processors, if domain knowledge is available to assist in identifying anomalous workloads in the extracted patterns based on the temporal input;
based on determining that domain knowledge is available to assist in the identifying, utilizing the domain knowledge to perform a workload pattern analysis to identify a portion of the patterns as indicative of anomalous workloads, labeling data comprising the portion of the patterns, and generating a first set of anomaly scores for the labelled data comprising the portion of the patterns;
based on determining that domain knowledge is not available to assist in the identifying, applying one or more unsupervised anomaly detection algorithms to identify an additional portion of the patterns as indicative of the anomalous workloads and labeling data comprising the additional portion of the patterns;
generating, by the one or more processors, a second set of anomaly scores for the labeled data comprising the portion of the patterns and the additional portion of the pattern and unlabeled data comprising the extracted patterns;
for each pattern of the patterns, calculating, by the one or more processors, a weighted sum comprising a combined anomaly score for the pattern based on combining one or more anomaly scores for the pattern selected one or more of the first set of anomaly scores and the second set of anomaly scores; and
determining, by the one or more processors, for each pattern of the patterns, whether the pattern indicates anomalous data or normal data based on utilizing an inference component to compare the combined anomaly score for each pattern to a pre-defined threshold.

2. The computer-implemented method, wherein generating the second set of anomaly scores for the labeled data is performed by semi-supervised anomaly detection algorithm, the method further comprising:
updating, by the one or more processors, the semi-supervised anomaly detection algorithm by utilizing patterns of the patterns determined to be anomalous data as training data; and
updating, by the one or more processors, the domain knowledge with patterns of the patterns determined to be the normal and abnormal data.

3. The computer-implemented method of claim 1, wherein generating the second set of anomaly scores for the labeled data comprises applying a few-shot anomaly detection model.

4. The computer-implemented method of claim 1, wherein the temporal input comprises service level metrics, infrastructure level metrics, and host-level metrics.

5. The computer-implemented method of claim 1, wherein the temporal input comprises a multi-channel comprised of system metrics from the resources comprising the computing system.

6. The computer implemented method of claim 1, wherein extracting patterns from the temporal input comprises:
embedding, by the one or more processors, a multi-channel with the patterns; and
filtering out noisy and redundant information across different metrics comprising the temporal output.

7. The computer-implemented method of claim 1, wherein the patterns comprise temporal patterns and structural patterns in data comprising the temporal output.

8. The computer-implemented method of claim 1, wherein the one or more unsupervised anomaly detection algorithm comprise ensemble learning.

9. The computer-implemented method of claim 1, wherein the labeled data identified by applying the one or more unsupervised anomaly detection algorithm comprises data comprising patterns from the patterns classified as anomalous with high confidence by the one or more unsupervised anomaly detection algorithm.

10. The computer-implemented method of claim 3, further comprising:
training, by the one or more processors, the few-shot anomaly detection model with the training data.

11. The computer-implemented method of claim 1, further comprising:
enhancing, by the one or more processors, the patterns determined to indicate anomalous data to provide explainability, wherein the enhancing is selected from the group consisting of:
selecting or weighing features in the patterns determined to indicate anomalous data for imbalanced binary classification, performing attention-guided feature weighting, and re-mapping the patterns determined to indicate anomalous data to infrastructure metrics of the computing system.

12. The computer-implemented method of claim 11, further comprising:
updating, by the one or more processors, the domain knowledge with the enhanced patterns.

13. The computer-implemented method of claim 1, further comprising:
based on the determining concluding that a given pattern indicates anomalous data, determining, for the given pattern whether the given pattern is comprised in a non-productive workload or in a hotspot.

14. The computer-implemented method of claim 13, further comprising:
based on determining that the given pattern is comprised in a non-productive workload, automatically shutting down, by the one or more processors, at least one resource of the computing system that handles the non-productive workload.

15. The computer-implemented method of claim 13, further comprising:
based on determining that the given pattern is comprised in a hotspot, migrating, by the one or more processors, at least a portion of the hotspot to a new resource in the computing system.

16. The computer-implemented method of claim 1, wherein generating the anomaly scores comprises:
for a portion of the labeled data labeled based on the workload pattern analysis, calculating, by the one or more processors, a distance that represents a divergence between the extracted patterns against representative patterns for the domain comprising the domain knowledge, and correlating the distance with the anomaly scores; and
for portions of the data not labeled based on the workload pattern analysis, applying a few-shot anomaly detection model to generate the anomaly scores.

17. A computer system comprising:
a memory; and
one or more processors in communication with the memory, wherein the computer system is configured to perform a method, said method comprising:
obtaining, by the one or more processors, temporal input from resources comprising a computing system;
extracting, by the one or more processors, patterns from the temporal input;
determining, by the one or more processors, if domain knowledge is available to assist in identifying anomalous workloads in the extracted patterns based on the temporal input;
based on determining that domain knowledge is available to assist in the identifying, utilizing the domain knowledge to perform a workload pattern analysis to identify a portion of the patterns as indicative of anomalous workloads, labeling data comprising the portion of the patterns, and generating a first set of anomaly scores for the labelled data comprising the portion of the patterns;
based on determining that domain knowledge is not available to assist in the identifying, applying one or more unsupervised anomaly detection algorithms to identify an additional portion of the patterns as indicative of the anomalous workloads and labeling data comprising the additional portion of the patterns;
generating, by the one or more processors, a second set of anomaly scores for the labeled data comprising the portion of the patterns and the additional portion of the pattern and unlabeled data comprising the extracted patterns;
for each pattern of the patterns, calculating, by the one or more processors, a weighted sum comprising a combined anomaly score for the pattern based on combining one or more anomaly scores for the pattern selected one or more of the first set of anomaly scores and the second set of anomaly scores; and
determining, by the one or more processors, for each pattern of the patterns, whether the pattern indicates anomalous data or normal data based on utilizing an inference component to compare the combined anomaly score for each pattern to a pre-defined threshold.

18. The computer system of claim 17, wherein generating the second set of anomaly scores for the labeled data is performed by semi-supervised anomaly detection algorithm, the method further comprising:
updating, by the one or more processors, the semi-supervised anomaly detection algorithm by utilizing patterns of the patterns determined to be anomalous data as training data; and
updating, by the one or more processors, the domain knowledge with patterns of the patterns determined to be the normal and abnormal data.

19. A computer program product comprising:
one or more computer readable storage media and program instructions collectively stored on the one or more computer readable storage media readable by at least one processing circuit to perform a method comprising:
obtaining, by the one or more processors, temporal input from resources comprising a computing system;
extracting, by the one or more processors, patterns from the temporal input;
determining, by the one or more processors, if domain knowledge is available to assist in identifying anomalous workloads in the extracted patterns based on the temporal input;
based on determining that domain knowledge is available to assist in the identifying, utilizing the domain knowledge to perform a workload pattern analysis to identify a portion of the patterns as indicative of anomalous workloads, labeling data comprising the portion of the patterns, and generating a first set of anomaly scores for the labelled data comprising the portion of the patterns;
based on determining that domain knowledge is not available to assist in the identifying, applying one or more unsupervised anomaly detection algorithms to identify an additional portion of the patterns as indicative of the anomalous workloads and labeling data comprising the additional portion of the patterns;
generating, by the one or more processors, a second set of anomaly scores for the labeled data comprising the portion of the patterns and the additional portion of the pattern and unlabeled data comprising the extracted patterns;
for each pattern of the patterns, calculating, by the one or more processors, a weighted sum comprising a combined anomaly score for the pattern based on combining one or more anomaly scores for the pattern selected one or more of the first set of anomaly scores and the second set of anomaly scores; and
determining, by the one or more processors, for each pattern of the patterns, whether the pattern indicates anomalous data or normal data based on utilizing an inference component to compare the combined anomaly score for each pattern to a pre-defined threshold.

20. The computer program product of claim 19, wherein generating the second set of anomaly scores for the labeled data is performed by semi-supervised anomaly detection algorithm, the method further comprising:
updating, by the one or more processors, the semi-supervised anomaly detection algorithm by utilizing patterns of the patterns determined to be anomalous data as training data; and
updating, by the one or more processors, the domain knowledge with patterns of the patterns determined to be the normal and abnormal data.
